(19) United States
(12) Patent Application Publication
(10) Pub. No.: US 2024/0077661 A1
(43) Pub. Date: Mar. 7, 2024

(54) Systems With Coated Transparent Layers

(71) Applicant: Apple Inc., Cupertino, CA (US)

(72) Inventor: Vijayen S. Veerasamy, Sunnyvale, CA (US)

(21) Appl. No.: 18/340,167

(22) Filed: Jun. 23, 2023

Related U.S. Application Data
(60) Provisional application No. 63/404,394, filed on Sep. 7, 2022.

(51) Int. Cl. G02B 5/28; B60J 1/00; B60J 1/20

(52) U.S. Cl. CPC G02B 5/281; B60J 1/001; B60J 1/20; H04B 1/3822

(57) ABSTRACT

A system may have a support structure and a window that separate an exterior region from an interior region. The window may have one or more glass layers with a thin-film interference filter that is configured to block infrared light while transmitting visible light. The filter may be transparent to radio-frequency signals so that a radio-frequency transceiver in the interior may transmit and receive radio-frequency signals through the filter. The filter may have one or more thin-film metal layers such as one or more thin-film crystalline silver layers that are patterned to form isolated metal islands and may have transparent inorganic thin-film dielectric layers interspersed with the metal layers.

This application claims the benefit of provisional patent application No. 63/404,394, filed Sep. 7, 2022, which is hereby incorporated by reference herein in its entirety.

### FIELD

This relates generally to systems with transparent layers, and, more particularly, systems with coated windows.

### BACKGROUND

Buildings, mobile systems, and other systems may be provided with windows. To control heat, the windows may be provided with coatings that block infrared light.

### SUMMARY

A system may have support structure and a window. The support structure and window may separate an exterior region surrounding the system from an interior region within the system.

The window may have one or more glass layers. One of the glass layers may have a thin-film interference filter coating that is configured to block infrared light while transmitting visible light. The filter coating may be transparent to radio-frequency signals so that a radio-frequency transceiver in the interior region may transmit and receive radio-frequency signals through the filter. The filter coating may have one or more thin-film metal layers such as one or more crystalline silver layers that are patterned to form isolated metal islands and may have transparent inorganic thin-film dielectric layers interspersed with the metal layers.

### BRIEF DESCRIPTION OF THE DRAWINGS

FIG. 1 is a cross-sectional view of an illustrative system in accordance with an embodiment.

FIG. 2 is a cross-sectional side view of an illustrative coater for depositing thin-film coatings in accordance with an embodiment.

FIG. 3 is cross-sectional side view of an illustrative glass layer on which a patterned metal layer has been formed using a coater of the type shown in FIG. 2 in accordance with an embodiment.

FIG. 4 is a cross-sectional side view of an illustrative window with at least one glass layer having a coating that includes one or more patterned metal layers in accordance with an embodiment.

FIG. 5 is a cross-sectional side view of an illustrative glass layer with a coating in accordance with an embodiment.

FIG. 6 is a top view of a portion of an illustrative glass layer with a coating in accordance with an embodiment.

### DETAILED DESCRIPTION

A system may have a coated glass layer. The glass layer may form all or part of a window in the system. The coating may be a thin-film interference filter coating that is configured to block infrared light such as infrared solar radiation while passing visible light. To provide the coated glass layer with a desired radio-frequency transparency and thereby allow radio-frequency transceivers in the interior of the system to transmit and receive radio-frequency signals through the coated glass layer, metal layers in the coating may be patterned. For example, a metal layer may be patterned during coating operations to divide the layer into discrete metal islands separated by gaps. The metal islands and gaps may be configured to reduce the visibility of metal layer patterning due to light diffraction.

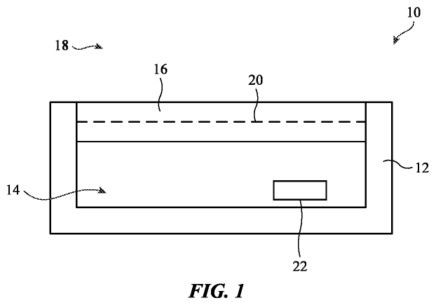

FIG. 1 is a cross-sectional side view of an illustrative system of the type that may include a coated glass layer. As shown in FIG. 1, system 10 may include a support such as support 12 and one or more windows such as window 16. As shown by line 20, window 16 may contain one or more transparent layers. The layers may be polymer layers, glass layers, or other transparent layers. In an illustrative configuration, which may be described herein as an example, window 16 includes one or more glass layers. The glass layers may, as an example, include a first glass layer and a second glass layer that are laminated together with an elastomeric polymer interlayer such as a polyvinyl butyral (PVB) layer. One or both of the glass layers in window 16 may be coated with a radio-transparent infrared-light-blocking-and-visible-light-transmitting thin-film interference filter coating (sometimes referred to as a solar rejection coating, infrared-blocking layer, or low-e coating). As an example, the first glass layer may have an infrared-blocking coating that faces a PVB layer and the second glass layer, which may not include an infrared-blocking coating, may be laminated to the first layer with the PVB layer.

As shown in FIG. 1, window 16 and support 12 may separate interior region 14 of system 10 from an exterior region (region 18) that surrounds system 10. System 10 may be a building, a mobile system (e.g., a vehicle), and/or other suitable system. In arrangements in which system 10 is a vehicle, support 12 may be a vehicle body.

System 10 may include electrical components in interior region 14 such as sensors, lights, displays, buttons, radio-frequency receivers and transmitters, and/or other electrical and/or optical equipment. In an illustrative arrangement, these components may include radio-frequency circuitry such as one or more radio-frequency transceivers. In the example of FIG. 1, radio-frequency transceiver 22 is located in interior region 14 and transmits radio-frequency signals through window 16 to receivers in exterior region 18 and receives radio-frequency signals through window 16 from transmitters in exterior region 18. To ensure satisfactory operation of transceiver 22, the coating(s) on the one or more glass layers in window 16 are preferably radio-frequency transparent (sometimes referred to as radio-transparent). Window 16 may, for example, be transparent to radio waves at the frequencies of operation of transceiver 22, which may include radio-frequencies of at least 100 MHz, at least 300 MHz, at least 700 MHz, 0.01-300 GHz, 10-70 GHz, less than 300 GHz, less than 50 GHz, 100 MHz to 300 GHz, millimeter wave frequencies, and/or other suitable frequencies.

To reject infrared radiation, the coating of window 16 may be formed from one or more layers of a metal that reflects infrared light such as crystalline silver. These metal layers may be formed as part of a stack of thin-film layers. The stack of thin-film layers may include the metal layers (e.g., silver layers) and interspersed transparent dielectric layers that have a higher refractive index than the metal layers. By alternating higher and lower refractive index layers and by configuring the refractive index values and thicknesses of the layers of the thin-film stack, the thin-film stack may be configured to form a thin-film interference filter with a desired light transmission spectrum. The light transmission spectrum of the filter may, as an example, exhibits low transmission (e.g., high reflectivity) for infrared light while exhibiting high transmission for visible light.

Radio-frequency transparency for window 16 may be ensured by patterning the metal layer(s) in the coating. In particular, each metal layer may be divided into a pattern (e.g., an array) with numerous metal islands separated by gaps in which no metal is present. The gaps may be organized to form a grid of metal-free lines separating the metal into isolated metal islands (sometimes referred to as metal patches). The grid may have crisscrossed vertical and horizontal lines in which metal is not present, may be formed from lines having hexagonal shapes, having octagonal shapes, having triangular shapes, having rectangular shapes, and/or having any other suitable shapes. If desired, the gaps may be organized to form irregular patterns of lines (e.g., irregular grids that have randomly shaped lines and/or lines that have a variety of different orientations). When the metal-free lines are organized in an irregular fashion, the resulting isolated metal islands may have irregular shapes (e.g., some metal patches may be rectangular, some may be triangular, some may be hexagonal, some may have curved sides, the patches may have numerous different sizes, etc.).

The islands of metal on window 16 may have lateral dimensions (widths in first and second orthogonal directions across the surface of each island and/or minimum and maximum widths across the surface of each island) of 2-400 microns, 3-300 microns, 4-200 microns, 4-100 microns, 4-75 microns, at least 3 microns, at least 5 microns, at least 10 microns, at least 20 microns, at least 50 microns, at least 100 microns, 20-300 microns, 25-400 microns, 10-200 microns, less than 1 mm, less than 500 microns, less than 400 microns, less than 300 microns, less than 200 microns, less than 100 microns, less than 50 microns, and/or other suitable lateral dimension. As an example, a metal island may have a width A along a first lateral dimension (or may have a minimum width A), may have a width B along a second lateral dimension that is orthogonal to the first lateral dimension (or may have a maximum width B), and may have a thickness Z that is 1-30 nm along a third (thickness) dimension that is orthogonal to the first and second lateral dimensions. The values of A and B may each be 2-400 microns, 3-300 microns, 4-200 microns, 4-100 microns, 4-75 microns, at least 3 microns, at least 5 microns, at least 10 microns, at least 20 microns, at least 50 microns, at least 100 microns, 20-300 microns, 25-400 microns, 10-200 microns, less than 1 mm, less than 500 microns, less than 400 microns, less than 300 microns, less than 200 microns, less than 100 microns, less than 50 microns, and/or other suitable lateral dimension. The pattern of metal-free gaps associated with the metal-free lines or other patterned metal-free areas that are used in dividing the metal layer(s) into the array of islands (metal patches) may have gap widths (sometimes referred to as linewidths) of at least 200 nm, at least 400 nm, at least 800 nm, at least 1 micron, at least 1.5 microns, at least 3 microns, at least 5 microns, less than 100 microns, less than 50 microns, less than 20 microns, 1-3 microns, 1-10 microns, 1-20 microns, 0.2-20 microns, 2-50 microns, 5-20 microns, and/or other suitable thicknesses. About 1-6%, at least 1% of the metal, at least 2% of the metal, less than 15% of the metal, 1-10% of the metal 2-5% of the metal, or other suitable fraction of the metal in the coating may be removed in forming the grid of lines and/or other gaps that separate the metal layer into the array of metal islands, thereby ensuring satisfactory radio-transparency while maintaining a desired amount of infrared light blocking capability for window 16. The sizes of the gaps (e.g., the linewidths of the metal-free lines in the grid) and islands may be configured to help reduce the visibility of the patterning in the metal to the naked eye. In particular, to prevent diffraction effects and/or other undesired optical effects that could cause patterns in the coating to be visible to the naked eye, the metal layer(s) in the coating on window 16 may be patterned into an array of islands that vary in shape, size, orientation, and/or location within the coating (e.g., pseudorandom variations may be made in these parameters). By varying island and/gap characteristics such as these as a function of position across window 16, visible light diffraction effects can be reduced or eliminated so that window 16 does not have any visible artifacts arising from the patterning of the metal layer(s). Island sizes and gap widths may also be maintained at relatively small values to help reduce pattern visibility.

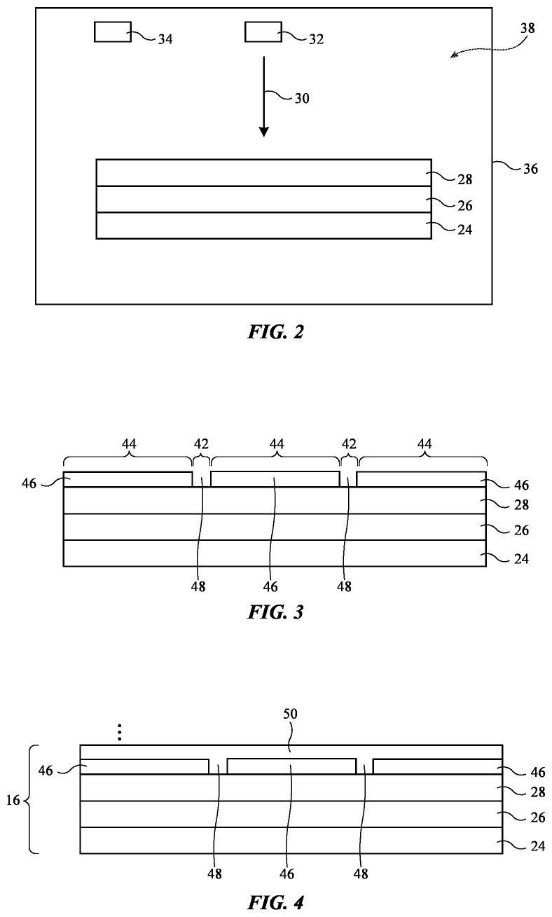

Illustrative equipment for coating one or more glass layers for window 16 is shown in FIG. 2. As shown in FIG. 2, coater 36 may have an interior region such as region 38 that can be maintained under vacuum during thin-film deposition operations. Coater 36 may have one or more material sources such as source 34 for depositing thin-film layers of metal (e.g., silver) and dielectric (e.g., metal oxides, etc.). Coater may be a physical vapor deposition tool (e.g., an evaporator or a sputterer) and/or may be equipment for performing chemical vapor deposition, spray pyrolysis and/or other types of thin-film deposition. During operation, coater 36 may be used to deposit thin-film layers on one or more glass layers or other transparent substrates for window 16. The thin-film layers may form a radio-transparent infrared-light-blocking-and-visible-light-transmitting coating. In an illustrative configuration, the coating is configured to exhibit sufficient visible light transparency so that the transmission of the coating at a visible light wavelength of 500 nm is at least 50%, at least 70%, at least 85%, or at least 95% and is configured to at least partly block infrared light by reflecting sufficient infrared light so that the transmission of the coating at an infrared wavelength of 1.5 microns is less than 30%, less than 25%, less than 20%, or less than 10%. In this configuration, the coating blocks (e.g., reflects) at least 70%, at least 75%, at least 80%, or at least 90% of infrared light at a wavelength of 1.5 microns).

Coater 36 may include in-situ patterning equipment (e.g., equipment that operates within the vacuum in region 38) for modifying particular portions of the surface of a glass layer or other substrate. This equipment may include an elastomeric pad such as a silicone pad that can be pressed against the surface of a glass substrate and/or may have a light source (e.g., a source of visible laser light, ultraviolet light, X-rays, and/or other radiation) and/or a source of electrons or other particles that can be used in modifying selected areas of the glass surface. The silicone pad or a pad formed of other materials may include a raised pattern (e.g., a raised grid) so that only selected portions of the surface of the glass substrate are contacted by the pad when the pad is pressed against the substrate.

Application of light to a desired local area of the surface of a substrate during coating operations is illustrated by light 30 of FIG. 2. Light 30 (and/or other sources of patterning) may be produced by patterning tool 32. Light 30 may be visible light, ultraviolet light, and/or infrared light. In general, patterning may be accomplished by applying patterned light or other patterned radiation (e.g., X-rays), may be accomplished by applying electrons or other particles, and/or may be accomplished by directly contacting a pad or other object against the surface of the substrate. Illustrative arrangements in which tool 32 uses light 30 such as visible light for patterning operations are sometimes described herein as an example.

Accordingly, tool 32 of FIG. 2 may be a source of patterned energy such as a source of patterned light, a source of patterned X-rays, or other patterned radiation, may be a source of patterned electrons or other particles, and/or may be a patterned contact pad. A shadow mask, light-redirecting optics (e.g., a diffraction grating, refractive optical elements such as prisms and lenses, mirrors), and/or other patterning and/or masking structures may be used by tool 32 in supplying patterning applied light, patterned applied electrons, and/or other patterned applied radiation, so that only a grid (or other desired pattern) of lines is irradiated on a target substrate. If desired, a beam steerer (e.g., a pivoting minor controlled by an electrically adjusted motor in tool 32, etc.) may be used in moving a light beam or electron beam over some of the surface of the glass substrate. Using one or more of these approaches, a patterned area (e.g., a grid of lines separating regions into isolated islands, an array of dots, and/or other patterned regions on the glass substrate) may be treated selectively (e.g., selectively exposed to light or X-rays, selectively exposed to electrons or other particles, and/or selectively contacted by a raised portion of a patterned pad), whereas a remaining area (e.g., an array of isolated islands/patches) may remain untreated (e.g., uncontacted by the pad, unexposed to light, unexposed to electrons, etc.).

Following selective treatment of certain areas of substrate surface (e.g., the area irradiated by light 30 or contacted by the patterned pad in the example of FIG. 2), thin-film metal that is being applied to the surface by coater 36 will selectively deposit in non-treated (untreated) areas, leaving only insignificant trace amounts of metal in the treated areas. The metal in the non-treated areas is sufficiently thick to form a conductive thin-film metal layer for the thin-film interference filter, whereas due to alterations in the physical properties of the treated surface, this metal layer does not form in the treated areas.

Selective surface treatment using a patterned elastomeric pad, light such as laser light or other light, an electron source, or other selective surface treatment in coater 36 can therefore be used to impose a desired pattern on the metal layer(s) being deposited on the substrate (e.g., on a glass layer in window 16 that is coated with coater 36). In this way, a grid of metal-free lines or other pattern of metal-free lines (e.g., a set of metal-free gaps between metal islands) may be created in each thin-film metal layer in the filter coating on the substrate. The metal-free area of the grid of lines or other metal-free gaps serves as an opening through which radio waves pass and the lines isolate the metal of each thin-film metal layer into individual islands. The metal-free islands are preferably sufficiently small (e.g., the lateral dimensions of the islands are sufficiently small) to disrupt induced current flow in the metal islands when exposed to radio-frequency waves (e.g., waves having wavelengths sufficiently larger than the lateral dimensions of the islands such as wavelengths of at least 1 cm at least 5 cm, or at least 10 cm, as examples). As a result, the process of dividing the metal layer(s) into isolated metal patches helps to reduce radio-wave reflections when the thin-film metal layer is exposed to radio waves. The patterned metal layers will therefore exhibit radio-transparency (e.g., a transmission of at least 50% at a radio frequency of 2.4 GHz as an example) and the coated glass layer(s) in window 16 will have sufficient radio-frequency transparency to allow radio-frequency transceiver circuitry 22 to satisfactorily transmit and receive radio waves through window 16.

FIG. 3 is a cross-sectional side view of an illustrative window substrate during coating operations with coater 36.

Initially, a transparent substrate layer such as layer 24 (e.g., a glass layer or other transparent substrate layer) may be coated with a transparent dielectric layer such as layer 26 using coater 36. Layer 26, which may sometimes be referred to as dielectric A, may be a metal oxide (e.g., zinc tin oxide, titanium oxide, etc.), may be silicon nitride, and/or may be formed from other inorganic dielectric material. The thickness of layer 26 may be 50-100 nm, at least 5 nm, at least 10 nm, at least 25 nm, less than 1000 nm, less than 500 nm, less than 250 nm, 10-500 nm, or other suitable thickness. Sources such as source 34 may be used in coater 36 to supply the elements used in depositing layer 26. Layer 26 may be deposited as a blanket thin-film layer that is not patterned by tool 32 (e.g., layer 26 may be an unpatterned thin-film dielectric layer, sometimes referred to as a blanket dielectric film or unpatterned blanket dielectric film).

After depositing layer 26, another dielectric layer such as layer 28 may be deposited. Layer 28 may be a transparent thin-film inorganic dielectric layer that serves as a seed layer for subsequent crystalline metal growth. As an example, layer 28 may be aluminum-doped zinc oxide that serves as a lattice-matched seed layer to support subsequent crystalline silver deposition. The thickness of layer 28 may be 8 nm, 2-32 nm, at least 1 nm, at least 2 nm, at least 4 nm, less than 80 nm, less than 50 nm, 1-50 nm, 4-16 nm, or other suitable thickness. Layer 28 may be deposited as an unpatterned thin-film coating layer (e.g., layer 28 may be a blanket film that is not patterned during or after deposition).

After seed layer 28 is deposited, coater 36 may use tool 32 to treat selective areas of the surface of layer 28 while leaving other areas untreated. Tool 32 may treat the surface of seed layer 28 while seed layer 28 is in vacuum in interior region 38 of coater 36).

As shown in FIG. 3, for example, area 42 may be treated (e.g., by exposure to laser light such as pulsed blue, green, or infrared light with a pulse time in the order of nanoseconds, flood exposure of area 42 to ultraviolet or blue flood-light selectively illuminating through a shadow mask, exposure to X-ray radiation, and/or exposure to other radiation, by irradiating area 42 with electrons, and/or by contacting area 42 with a pad having a pattern of raised material such as silicone or other elastomeric material). When treating area 42 with laser light, pulse energies below the ablation threshold of zinc oxide such as pulse energies of less than 0.3 J/cm² may be used so that the surface energy of the exposed zinc oxide of layer 28 changes so that during subsequent growth of silver film, the silver film will not wet the aluminum-doped zinc oxide of layer 28. This leads to the creation of voids in the growing silver film which de-wets and form islands. Area 42 may have the pattern of a grid of metal-free lines or any other suitable metal-free gap pattern that separates untreated area 44 into individual islands (e.g., an array of untreated patches). Viewed from above, metal-free area 42 may contain rows and columns of grid lines, a hexagonal pattern of grid lines, a grid that contains octagons and rectangles, randomly oriented metal-free lines and/or other metal-free gaps, and/or other metal-free pattern. Untreated area 44 may contain isolated untreated patches (e.g., an array of patches such as rectangular patches, hexagonal patches, octagonal patches, and/or untreated isolated islands of other shapes. If desired, isolated treated shapes (e.g., dots, crosses, and/or other treated island shapes) may be embedded within untreated islands. The use of flood illumination techniques may enhance throughput. The use of laser light exposure of area 42 using focusing optics may help provide a desired high resolution.

After modifying the surface of layer 28 in area 42, a thin-film metal layer may be deposited using a metal source in coater 36. As one example, a metal such as silver may be deposited while layer 28 is in vacuum in interior region 38. Pristine (untreated) areas of aluminum-doped zinc oxide provide a wettable surface for silver film deposition. In these untreated regions, the zinc oxide of layer 28 is highly textured (0001) and silver film grows hetero-epitaxially in a (111) orientation. The interfacial energy is high.

Due to modification of the surface of seed layer 28 during surface treatment with tool 32 (radiation exposure such as laser light exposure and/or X ray exposure, electron beam exposure, contact with the raised portions of the patterning pad, etc.), significant metal is only deposited in untreated area 44. Treated area 42 may receive only nano-scale particles of metal (e.g., small particles of silver or other metal that do not connect to each other and therefore do not form part of a conductive homogeneous metal film). In untreated area 44, in contrast, a crystalline metal (e.g., crystalline silver) may be deposited, as illustrated by patterned crystalline metal layer 46 (crystalline metal islands) of FIG. 4. The thickness of the thin-film layer of crystalline silver or other crystalline metal that is deposited may be 6-8 nm, at least 1 nm, at least 2 nm, at least 4 nm, less than 30 nm, less than 16 nm, less than 18 nm, less than 9 n, less than 8 nm, 3-16 nm, 3-12 nm, and/or other suitable thickness. The thickness of layer 46 is preferably sufficiently thin to allow the coating on substrate 24 transmit visible light while reflecting infrared light.

The islands of metal layer 46 that are formed in this way may have lateral dimensions of 5-10 microns, at least 1 micron, at least 2 microns, at least 5 microns, at least 15 microns, less than 100 microns, less than 50 microns, less than 20 microns, 1-100 microns, 2-75 microns, and/or other suitable lateral dimensions. The linewidth (gap width) of the lines in the grid of lines formed by treated areas 42 (see, e.g., the grid formed by the gaps of lines 48 in FIG. 4) may be 1 micron, at least 0.1 microns, at least 0.4 microns, at least 1 micron, at least 2 microns, at least 5 microns, at least 10 microns, less than 200 microns, less than 75 microns, less than 20 microns, less than 10 microns, less than 4 microns, less than 2 microns, 0.5-2 microns, 0.4-4 microns, 0.1-10 microns, and/or other suitable width. The upper right of FIG. 6 is a top view of an illustrative hexagonal grid pattern that may be formed from treated areas 42. Other patterns of metal-free gaps may be formed in layer 46, if desired. If desired, the thin-film interference filter properties of the treated and untreated areas may be configured to help minimize the optical contrast of the areas with and without silver present. In this way, the areas with no metallic components can have optical/cosmetic characteristics that are compatible with the areas containing silver films. For example, the visible light transmission T1 of the treated areas and the visible light transmission T2 of the untreated areas may be configured to differ by less than 25%, less than 10%, less than 3%, or less than 1% (as examples).

As shown in FIG. 4, after depositing patterned metal layer 46, additional layers of material may be deposited in a repeating thin-film stack until a coating of sufficient thickness is formed on substrate 24. For example, another layer of dielectric A or a different transparent inorganic dielectric (see, e.g., dielectric layer 50 of FIG. 4) may be deposited on layer 46 and may fill the gaps in layer 46, after which additional seed layers and patterned metal layers may be deposited to form a stack of thin-film layers for the filter coating on substrate 24. Alignment techniques such as mask alignment techniques and/or the use of laser optics techniques that maintain pattern registration across multiple layers may be used to help ensure that the patterns of the treated area 42 in different layers are satisfactorily aligned with each other. Gettering layers (e.g., one or more oxygen getter layers) and/or other layers of material (e.g., additional layers of the seed layer material and/or other materials) may optionally also be deposited during formation of the filter coating. The deposited thin-film layers in the stack have refractive index values and thicknesses selected to produce a desired light transmission spectrum for the filter coating (e.g., the stack of layers in the coating may be configured to implement an infrared-light-blocking-and-visible-light-transmitting thin-film interference filter. The filter coating on layer 24 may, as an example, contain two silver layers, three silver layers, or four or more silver layers. In each deposited silver layer, the grid of lines (gaps) in the silver being deposited may be aligned with a matching grid of lines in all previously deposited silver layers or, if desired, different silver layers may have different grid patterns and/or may have grid patterns that are not aligned with other silver layer grid patterns. Following coating of a glass layer such as layer 24 with a radio-transparent infrared blocking filter in this way, layer 24 may be laminated to one or more other glass layers 24 using an interposed elastomeric interlayer, thereby forming window 16 for system 10. For example, a first glass layer that has a radio-transparent infrared blocking filter may be laminated to a second glass layer that does not have a radio-transparent infrared blocking filter.

During operation in system 10, the gaps formed by the grid of lines in the metal layer(s) of the filter coating help provide window 16 with transparency to radio-frequency signals, so that transceiver 22 may transmit and receive radio-frequency signals through window 16 (even in systems in which radio-frequency signals are blocked due to the presence of metal structures in support 12). At the same time, the thicknesses and refractive index values of the inorganic dielectric layers and crystalline metal layers of the thin-film stack in the filter coating are configured to form a thin-film interference filter with a desired light transmission spectrum (e.g., a light transmission spectrum that blocks infrared light and that passes visible light, such as a spectrum characterized by a transmission of at least 80%, at least 90%, at least 98%, or at least 99% for visible light and a transmission of less than 20%, less than 10%, less than 2%, or less than 99% for infrared light).

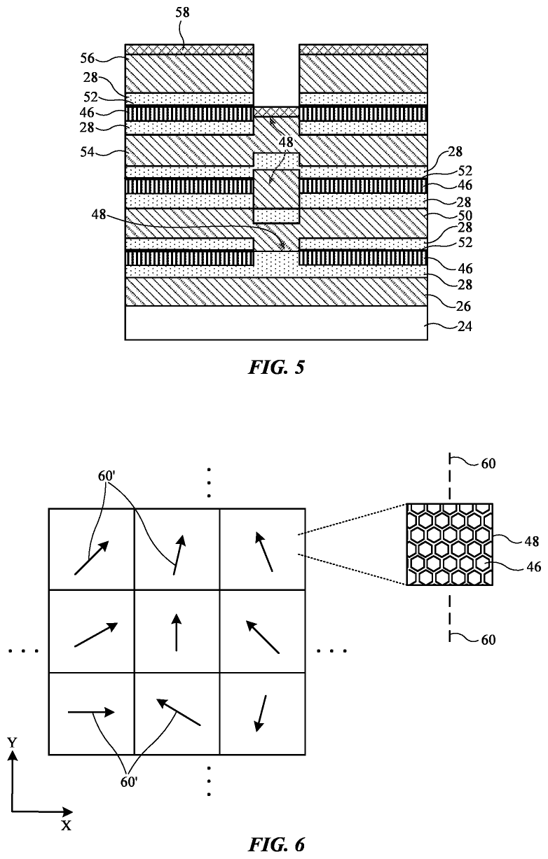

As described in connection with FIG. 4, the filter coating on layer 24 may contain one or more metal layers. FIG. 5 is a cross-sectional side view of layer 24 in an illustrative configuration in which the filter coating on layer 24 contains three metal layers 46 (e.g., three silver layers). As shown in FIG. 5, seed layer material for seed layers 28 may be deposited above and below each of layers 46. Optional oxygen getter layers 52 may be deposited on layers 46, if desired. Dielectric layers 50, 54, and 56 may separate respective seed layers 28. Layers 50, 54, and 56 may be formed from the same dielectric material (e.g., zinc tin oxide) or may be formed from different dielectric materials. Optional capping layer 58 (e.g., a layer of zirconium silicon oxide, zirconium oxide, etc.) may be provided on the top of the filter to enhance thermal and chemical stability.

FIG. 6 is a top view of a portion of layer 24 showing how the filter coating may have isolated islands of metal 46 separated by a grid of lines 48. Each metal island may have a lateral dimension along the X axis and a lateral dimension along the Y axis. Each metal island may also be characterized by a maximum lateral dimension and a minimum lateral dimension (which may or may not corresponding to a measurement taken along the X and Y axes of FIG. 6). In an illustrative configuration, the minimum and maximum lateral dimensions of each island (and/or the X and Y dimensions of each island) may each have a value of 2-400 microns, 3-300 microns, 4-200 microns, 4-100 microns, 4-75 microns, at least 3 microns, at least 5 microns, at least 10 microns, at least 20 microns, at least 50 microns, at least 100 microns, 20-300 microns, 25-400 microns, 10-200 microns, less than 1 mm, less than 500 microns, less than 400 microns, less than 300 microns, less than 200 microns, less than 100 microns, less than 50 microns, and/or other suitable lateral dimension. Metal 46 may, as an example, be patterned to form an array of hexagonal isolated metal islands (patches) or islands of other shapes. If desired, the visibility of the metal islands may be reduced by orienting different domains DM (sometimes referred to as tiles or regions) of metal islands with different angular orientations. Domains DM of FIG. 6 are rectangular (e.g., square), but domains DM may have other shapes, if desired (e.g., hexagons, triangles, etc.). The isolated metal islands of each domain may have an associated shared angular orientation (e.g., the grid of lines separating metal 46 into isolated islands and therefore all of the islands of each domain may be oriented along a particular axis such as axis 60 in the example of FIG. 6). By rotating the angular orientation of the metal islands in different domains differently (e.g., with pseudorandom orientations), diffraction effects that might otherwise be present over a larger area of the filter coating will be disrupted and made less visible. As shown in FIG. 6, each of nine domains DM in a portion of the filter coating may have an angular orientation axis 60′ that differs from the other eight domains DM in that portion of the filter coating (e.g., the axis 60′ of each of the nine domains DM of FIG. 6 may be oriented at a different angle with respect to the Y axis of FIG. 6). By randomizing the orientations of different domains of metal patches across the surface of layer 24 in this way, the visibility of the islands and grid lines in the filter coating can be reduced.

As demonstrated by the foregoing, selective in-situ treatment of seed layers 28 may be used to pattern deposited metal layers (e.g., silver layers) and thereby provide a filter coating with radio transparency. Using in-situ patterning techniques such as these may be faster (e.g., two orders of magnitude faster) than techniques involving selective ablation of an entire post-deposition filter coating stack.

The foregoing is merely illustrative and various modifications can be made to the described embodiments. The foregoing embodiments may be implemented individually or in any combination.

What is claimed is:

1. A coated glass layer, comprising:
a layer of glass having a surface; and
a radio-transparent thin-film interference filter coating on the surface that includes a stack of thin-film layers, wherein the stack of thin-film layers includes blanket inorganic dielectric films and includes a metal layer that is separated into isolated metal islands.

2. The coated glass layer defined in claim 1 wherein the metal layer is separated into the isolated metal islands by a grid of metal-free lines and wherein the metal-free lines have a linewidth of less than 100 microns.

3. The coated glass layer defined in claim 2 wherein the metal layer comprises crystalline metal.

4. The coated glass layer defined in claim 3 wherein the metal layer comprises crystalline silver.

5. The coated glass layer defined in claim 4 wherein the stack of thin-film layers is configured to provide the radio-transparent thin-film interference filter with a light transmission spectrum that blocks at least 70% of infrared light at a wavelength of 1.5 microns and that passes at least 70% of visible light at a wavelength of 500 microns.

6. The coated glass layer defined in claim 5 wherein each of the metal islands has a thickness of less than 16 nm.

7. The coated glass layer defined in claim 6 wherein the metal islands each have a minimum lateral dimension of 2-400 microns and each have a maximum lateral dimension of 2-400 microns.

8. The coated glass layer defined in claim 7 wherein the lines have a linewidth of 0.2-20 microns.

9. The coated glass layer defined in claim 8 wherein the blanket inorganic dielectric films comprise a dielectric seed layer on which the metal layer is grown.

10. The coated glass layer defined in claim 9 wherein the dielectric seed layer comprises aluminum-doped zinc oxide.

11. A system, comprising:
a support; and
a window in the support, wherein the window has a glass layer coated with a radio-transparent coating that at least partly blocks infrared light and at least partly transmits visible light and that has a metal layer with isolated metal islands.

12. The system defined in claim 11 wherein the window and the support are configured to separate an exterior region from an interior region, the system further comprising a radio-frequency transceiver in the interior region that is configured to transmit and receive radio-frequency signals through the radio-transparent coating.

13. The system defined in claim 12 wherein the isolated metal islands have minimum lateral dimensions of 25 microns to 400 microns and have maximum lateral dimensions of 25 to 400 microns.

14. The system defined in claim 13 wherein the isolated metal islands comprise crystalline metal with a thickness of less than 16 nm.

15. The system defined in claim 14 wherein the isolated metal islands are separated by lines having linewidths of 2 microns to 50 microns.

16. The system defined in claim 15 wherein the radio-transparent coating contains a stack of inorganic dielectric layers.

17. The system defined in claim 16 wherein the inorganic dielectric layers comprise a seed layer for the crystalline metal.

18. The system defined in claim 17 wherein the isolated metal islands are arranged in a plurality of domains including a first domain in which the isolated metal islands have a first angular orientation and a second domain in which the isolated metal islands have a second angular orientation that is different than the first angular orientation.

19. A vehicle, comprising:
a vehicle body;
a laminated glass window having a first glass layer laminated to a second glass layer with an elastomeric interlayer;
an infrared-light-transmitting-and-visible-light-blocking thin-film interference filter coating on the first glass layer having an array of metal islands; and
a radio-frequency transceiver configured to transmit and receive radio-frequency signals through the infrared-light-transmitting-and-visible-light-blocking thin-film interference filter coating.

20. The vehicle defined in claim 19 wherein the metal islands comprise crystalline silver islands having a thickness of less than 30 nm, having maximum lateral dimensions of less than 200 microns, and separated by lines with a linewidth of less than 20 microns.
